(19) United States
(12) Patent Application Publication
(10) Pub. No.: US 2014/0164220 A1
(43) Pub. Date: Jun. 12, 2014

(54) PAYMENT INSTRUMENT SELECTION

(71) Applicant: MICROSOFT CORPORATION, Redmond, WA (US)

(72) Inventors: Atulkumar Desai, Sammamish, WA (US); Patrick Derks, Seattle, WA (US)

(73) Assignee: Microsoft Corporation, Redmond, WA (US)

(21) Appl. No.: 13/707,568

(22) Filed: Dec. 6, 2012

(51) Int. Cl. G06Q 20/22

(52) U.S. Cl. CPC G06Q 20/227
USPC 705/39

(57) ABSTRACT

Example apparatus and methods concern helping a shopper figure out which payment instrument (e.g., card with frequent flyer miles, card with discount, card with hotel points, card with cash back, card with insurance) to use for a particular purchase. Example apparatus and methods identify payment options available for a purchase and identify incentives associated with the payment options. Example apparatus and methods compare the benefits (e.g., miles, points, discount, cash back) that will be provided to the purchaser for different payment options. Example apparatus and methods may then produce an ordered presentation of payment options to a consumer or to a purchase process. Example apparatus and methods may facilitate a consumer increasing the utility of participation in affinity programs, may facilitate a consumer achieving a reward status, may facilitate a consumer achieving a desired discount, or may generally improve the consumer's shopping experience.

### BACKGROUND

Shoppers have different ways to pay for things. At any given time, for any given purchase, the shopper may want to determine what is the “best” way to pay for something given that how they pay may affect rewards they receive. Different shoppers may have different definitions of the “best” way to pay for something and that definition may change from purchase to purchase, day to day, store to store, or at other times. The “best” way to pay may depend on the different payment instruments available to the purchaser and on the incentives associated with those different instruments. A purchaser may have options including, but not limited to, paying cash, using one of several credit cards, using a debit card, making an electronic funds transfer, or even agreeing to pay later. Thus, when buying something, a purchaser may have to decide between multiple different payment instruments, and the decision may be based on a large number of variables, some of which may be changing in real time.

The decision concerning which payment instrument to select may be complicated by several factors. For example, different discounts may be available for different instruments. Additionally, different incentives (e.g., points, miles, cash back) may be available for different instruments. Furthermore, some instruments may provide benefits like trip insurance, extended warranties, “no questions asked” return programs, and other benefits. Discounts, incentives, and other properties of payment instruments may vary over time, from store to store, or even based on the item purchased. To make things even more complicated, the discounts, incentives, and other benefits may depend on factors including, but not limited to, whether the purchase is being made online or in a store, whether the purchase is a first purchase or a repeat or habitual purchase, whether the purchase is for a good or service, what item or set of items is being purchased, the geographic location of the vendor, the geographic location of the purchaser, promotions in effect for the item(s), promotions in effect for the instrument(s), and the current unpaid balance associated with an account. Additionally, some credit cards may even have different incentives for different types of purchases (e.g., 1% for gas, 2% for food, 3% for clothes).

But analyzing payment instruments isn't just about looking at benefits. Payment instruments may also have costs. For example, payment instruments may have transaction costs, may have annual membership fees, may have different payment terms, and may have other costs. It may be difficult, if even possible at all, to compare the rewards and incentives for different payment instruments in a timely manner. For example, it may be difficult to compare the value of frequent flyer miles to hotel points to rental car points to extended warranties to trip insurance to discount rates to cash back rates all while standing in line at a cash register at a store.

As the number of payment instruments available to a purchaser increases, the decision about which payment instrument to use for a given transaction may become increasingly difficult. The decision making process may become so difficult that it becomes impractical for a consumer to make. Thus, the consumer may be unable to receive any benefit, let alone enhanced or maximized benefits, from the incentives, cash back, affinity programs, and other options available to them. Even if the decision can be made, it likely cannot be made in a practical time frame (e.g., while the consumer is at the cash register, while the consumer is buying an airline seat, while the consumer is engaged in an online auction). Not only can a consumer's delay annoy other customers in line, but the delay may cause the item for sale to become unavailable. For example, while trying to decide how to pay for an airline seat or for a ticket to a ball game, the seat or ticket may be purchased by someone else.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example apparatus and methods access data describing a purchaser, data describing an item being purchased (e.g., vendor, location, price), and data describing payment instruments available to the purchaser. Example apparatus and methods use the available data to evaluate payment instruments from the point of view of rewards available. The evaluation can be used to guide or to control the transaction.

Example apparatus and methods facilitate evaluating incentive information associated with payment options available to a buyer for a purchase. Example apparatus and methods may identify payment options available for the sale and then acquire incentive information for the payment options. With the incentive information available, example apparatus and methods may rank the available payment options in terms of the rewards possible through each payment option. Example apparatus and methods may also consider the costs associated with acquiring the different rewards through the different payment options.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example data flow associated with payment instrument selection.

FIG. 2 illustrates an example method associated with payment instrument selection.

FIG. 3 illustrates an example method associated with payment instrument selection.

FIG. 4 illustrates an example transformation from an instrument specific incentive format to a common incentive format.

FIG. 5 illustrates an example apparatus configured to perform payment instrument selection.

FIG. 6 illustrates an example apparatus configured to perform payment instrument selection.

FIG. 7 illustrates an example cloud operating environment.

FIG. 8 illustrates an example mobile computing device configured to perform payment instrument selection.

### DETAILED DESCRIPTION

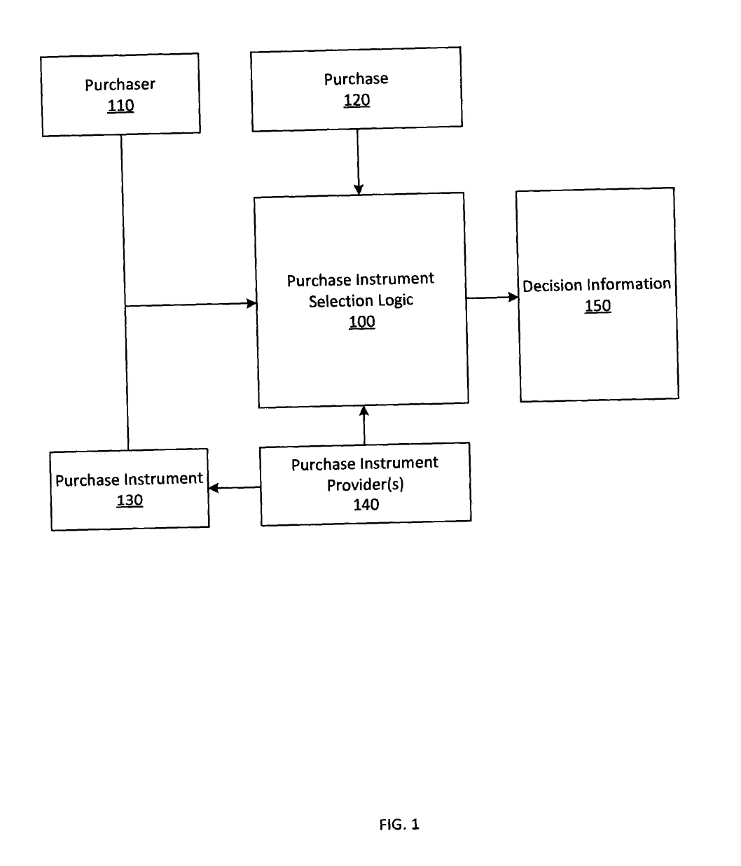

FIG. 1 illustrates an example data flow associated with payment instrument selection. A purchase instrument selection logic 100 accesses and evaluates data to facilitate providing information upon which a purchaser 110 can make a decision. For example, the purchase instrument selection logic 100 may access information about a purchaser 110. Learning about the purchaser 110 is an action that facilitates finding out what purchase instruments (e.g., credit cards, debit cards) may be available for the purchase. In addition to finding out who is making the purchase, the purchase instrument selection logic 110 may also acquire information about the purchase 120. For example, information about the item being bought, where the item is being bought, and how much the item costs may be acquired. The purchase instrument selection logic 100 may also acquire data about the purchase instruments 130 that are available. This data may include, for example, information about rewards available for a purchase instrument. The data about the purchase instruments 130 may be provided from purchase instrument providers 140. The purchase instrument selection logic 100 collects the available information and then provides decision information 150 about instruments and rewards. The decision information 150 may be, for example, an ordered list of instruments and their benefits.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

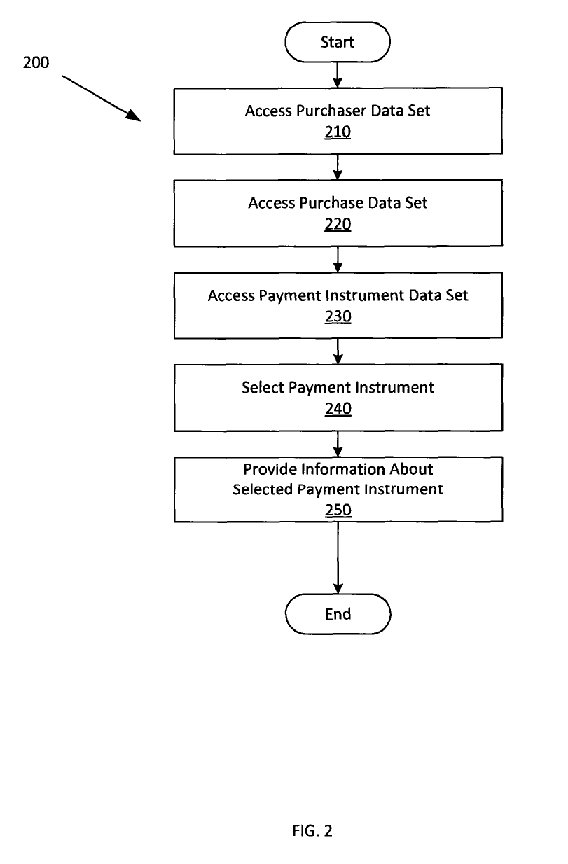

FIG. 2 illustrates an example method 200 associated with payment instrument selection. Method 200 is performed by an apparatus (e.g., computer, smart phone). Payment instruments may include, for example, credit cards, debit cards, gift cards, and other forms of payment. Different payment instruments may have different types of rewards or incentives associated with them. For example, a credit card associated with an airline may offer frequent flyer miles while a credit card associated with an online retailer may give discounts for purchases from that online retailer.

In different examples, method 200 may be performed on a single device, may be performed partially or completely in the cloud, may be performed on distributed co-operating devices, or may be performed other ways. In different examples, method 200 may be performed on devices including, but not limited to, a computer, a laptop computer, a tablet computer, a cash register, a point of sale device, a phone, and a smart phone.

Method 200 accesses several data sets. In different examples the data sets may be stored as separate data sets on separate devices, may be stored as separate data sets on a single device, may be stored as a single data set on a single device, and may be stored in other ways. In one embodiment, a device may access data sets stored in one location (e.g., cloud) when the device has network connectivity but may access data sets in another location (e.g., local memory) when the device does not have network connectivity. Online data may be more up-to-date than locally stored data, but locally stored data may be employed based on connectivity or decision time concerns.

Method 200 includes, at 210, accessing a purchaser data set. The purchaser data set includes information about the person or process that is making the purchase. Thus the purchaser data set includes information that identifies the purchaser and that facilitates finding payment instrument information associated with the purchaser. The purchaser may be, for example, a human or an automated purchasing process. In different embodiments, accessing the purchaser data set may involve accessing data stored in different locations or accessing data in different ways. Accessing the data set may involve actions including, but not limited to, receiving the purchaser data set, receiving a link to the purchaser data set, binding to the purchaser data set, interacting with a computer file that stores a portion of the purchaser data set, interacting with a computer memory that stores a portion of the purchaser data set, communicating with a local data store that stores a portion of the purchaser data set, communicating with a remote data store that stores a portion of the purchaser data set, and communicating with a cloud-based data store that stores a portion of the purchaser data set. The purchaser data set may store information including, but not limited to, a purchaser name, a purchaser identifier, a purchaser device identifier, a purchaser geographic location, and a set of payment instruments currently available to the purchaser. Accessing the data purchaser data set includes one apparatus (e.g., computer) interacting with another apparatus (e.g., memory).

Method 200 also includes, at 220, accessing a purchase data set. The purchase data set includes information about an item to be purchased. The item may be a good, a service, a ticket, or other thing that can be purchased. The information about the item to be purchased will, at the least, identify the item and facilitate identifying other information (e.g., purchase price) of the item. In one embodiment, accessing the purchase data set may involve actions similar to those involved in accessing the purchaser data set. Accessing the purchase data set includes one apparatus (e.g., computer) interacting with another apparatus (e.g., memory). The purchase data set may store information including, but not limited to, the item to be purchased, the vendor of the item, whether the purchase is an online purchase, whether the purchase is an in-person purchase, a promotion associated with the item, a frequency associated with the purchase, a geographic location of the vendor of the item, and a volatility of the item. The volatility of the item concerns how quickly an attribute (e.g., price, availability, incentive) of the item may change.

Method 200 also includes, at 230, accessing a payment instrument data set. The information about a payment instrument will include information to identify the instrument and information for identifying an incentive associated with the instrument. In one embodiment, accessing the payment instrument data set may involve actions similar to those involved in accessing the purchase data set and the purchaser data set. Accessing the purchase instrument data set includes one apparatus (e.g., computer) interacting with another apparatus (e.g., memory). The payment instrument data set may store information about a set of payment instruments currently available to the purchaser. In one embodiment, the information about instruments that are currently available may be acquired from the user, from instruments (e.g., credit cards) in the user's possession, from an electronic wallet that stores information about the instruments, and from other places authorized by the purchaser. In different transactions, the information may be acquired from a source that is local to the purchaser (e.g., purchaser phone) or may be acquired from a source remote from the purchaser (e.g., database in the cloud).

The payment instrument data set may store information including, but not limited to, a payment instrument name, a payment instrument identifier, a payment instrument account identifier, a payment instrument reward, a payment instrument cost, a payment instrument boundary, a payment instrument history, a payment instrument comparative reward, a payment instrument reward native format, a payment instrument reward common format, a payment instrument conversion rule, a payment instrument balance, and a payment instrument application rule.

The payment instrument reward may be described in a format that is native to the instrument. For example, an airline credit card may describe its incentive in terms of frequent flyer miles while a retailer credit card may describe its incentive in terms of cash back or as store credit available at retail outlets. It may be difficult for a consumer to compare and decide between these native formats. Thus, data about a payment instrument may also include a value that can be displayed in a payment instrument reward common format. In one embodiment, rather than code the intelligence for how to convert from a native format to a common format into an application that processes incentive data, data about a payment instrument may also include a rule that describes how to make the conversion.

Rewards and costs may vary based on boundaries associated with a payment instrument. For example, a first “introductory” (e.g., higher) level of rewards may be available for an introductory period of time or until a threshold amount of purchases or rewards have been acquired. However, a second “regular” (e.g., lower) level of rewards may be available after the introductory promotion has been consumed. Therefore, information about a payment instrument may include information about an account balance, a reward history, and a boundary associated with the instrument. The incremental or marginal value of a reward may change as the boundary is approached.

Rewards and costs may also vary based on boundaries associated with the balance or the amount of activity on an account. For example, a frequent flyer program may provide different levels of rewards to Bronze, Silver, Gold, and Platinum Elite members. If a consumer is close to the boundary between Bronze and Silver Elite, and a purchase would push the consumer into the higher category, then the marginal or incremental value of a frequent flyer mile may be different than for a purchase that would not put the consumer over the boundary. This incremental or marginal value may vary as a deadline approaches for reaching a boundary. For example, a frequent flyer mile that would put a customer over a threshold may have a first higher value at the beginning of a reward period and a lower value at the end of the reward period.

Additionally, a payment instrument may charge different amounts for new balances, old balances, and balances that exceed a threshold. For example, a debit card may charge no interest for purchases that do not exceed a balance in an account but may charge both interest and an overdraft fee for purchases that exceed the balance in the account. Since payment instruments may be shared, (e.g., between family members, between business partners, by employees), it may difficult for any individual purchaser to understand the balance situation at purchase time.

Information about a payment instrument may also include a rule that describes additional information that may control when the instrument is to be employed. The rule may be user defined, automatically defined, automatically defined and then user adapted, or may be defined in other ways. In one embodiment, the rule may be used in conjunction with, for example, the reward as converted to the common format. By way of illustration, a rule may describe that an instrument is not to be employed if it will produce an overdraft fee. The rule may be used, for example, to artificially change the reward as converted to the common format to a value that makes it less likely or substantially certain that the instrument will not be employed. By way of further illustration, a rule may describe that an instrument is to be employed if it will produce an extended warranty or theft protection for a consumer electronics purchase that exceeds a threshold amount. In one embodiment, this rule may be employed to artificially inflate the reward value to make it more likely or substantially certain that the instrument will be employed for certain purchases. While inflating is described, other techniques may be employed for making it more or less likely that an instrument will be selected.

Method 200 also includes, at 240, controlling a computer to select a payment instrument for purchasing the item. The control is exercised by, for example, a process running on an apparatus. The selection may be based, at least in part, on a reward available to the purchaser in response to purchasing the item using the payment instrument. In one embodiment, the reward is determined based on information in the purchaser data set, the purchase data set, and the payment instrument data set. For example, the reward may be a function of the purchase price for an item, the category (e.g., good, service, ticket) of the item, and the incentive available for the item if the instrument is used.

Method 200 also includes, at 250, providing information about the selected payment instrument. Providing the information involves the use of an apparatus. In one embodiment, controlling the computer to provide information about the payment instrument includes controlling the computer to provide information about a set of payment instrument options to the purchaser. In different embodiments, the computer may be controlled to provide the set of payment instrument options in less than one second, in less than one tenth of a second, in less than one hundredth of a second, in less than one thousandth of a second, and in other shorter times.

Providing the information may include producing a display that will help the consumer make the decision. The display may be, for example, an ordered list that shows instruments, native rewards, and comparative rewards. The display may also be, for example, a single record that shows the “best” instrument as determined by applying the rules available in the payment instrument selection data. In another example, providing the information may include providing the information to a cash register or point of sale device or process with which the purchaser is interacting. This example facilitates reducing transaction times because the decision is made for the purchaser and provided to the point of sale device or process without consumer interaction.

Payment instruments may provide rewards, but may also incur costs. For example, while a cash transaction or debit card transaction may be fee free, a credit card transaction may face a surcharge of one percent or more. Thus, in one embodiment, method 200 may include identifying net rewards available for the payment instruments and then controlling the computer to select the payment instrument that will produce the largest net reward. The net reward may be computed by subtracting the cost from the reward, or in other ways.

In different embodiments, method 200 may be performed by different processes in different locations. In one embodiment, method 200 may include controlling a cloud service to select the payment instrument and then controlling a device available to the purchaser to provide information concerning the selected payment instrument to the purchaser.

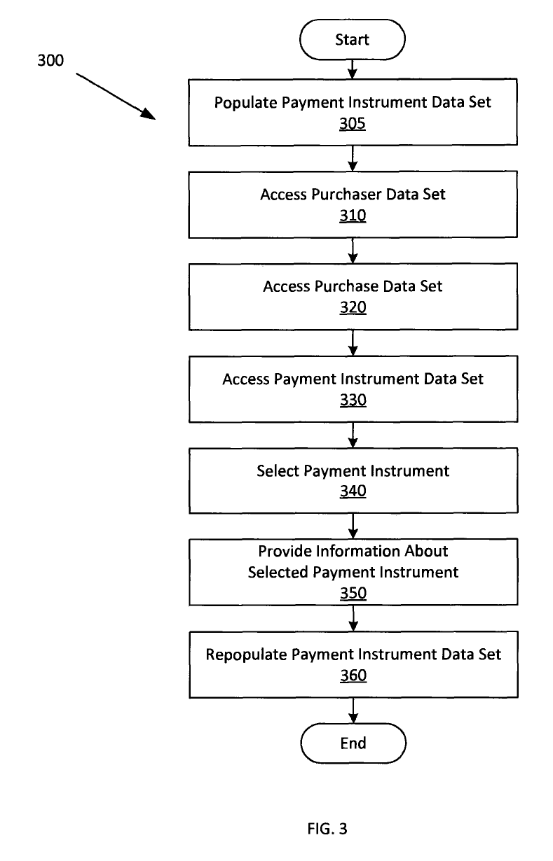

FIG. 3 illustrates an example method 300 associated with payment instrument selection. Method 300 includes some actions similar to actions in method 200. For example, method 300 includes accessing data sets at 310, 320, and 330, selecting a payment instrument at 340, and providing information about the selected payment instrument at 350. However, method 300 also includes additional actions.

Method 300 also includes, at 305, populating the payment instrument data set. In one embodiment, populating the payment instrument data may include automatically acquiring information via a computer communication from a payment instrument provider. In another embodiment, populating the payment instrument data may include receiving data input by a user. The user may input the data on their own initiative, may input the data in response to a payment instrument being detected in their real wallet or their virtual wallet, or may input the data in response to some other stimulus.

Method 300 may also include, at 360, repopulating at least a part of the payment instrument data set. While the repopulating is illustrated at action 360, the repopulating may occur at times including, but not limited to, upon detecting a change in a reward associated with a payment instrument, upon detecting that a purchaser is about to make a purchase, upon the expiration of a time period, at a scheduled time, upon detecting a balance change, and upon receiving a signal from a user. Repopulating the payment instrument data set may involve actions including, but not limited to, receiving data from a payment instrument provider via a computer communication, and receiving data from a user. Repopulating may occur periodically, may occur when connectivity is re-established, or at other times.

Additionally, selecting a payment instrument at 340 may include considering future scheduled payments. For example, selecting a payment instrument may be based, at least in part, on a future scheduled payment associated with a payment instrument.

While FIGS. 2 and 3 illustrates various actions occurring in serial, it is to be appreciated that various actions illustrated in FIGS. 2 and 3 could occur substantially in parallel. By way of illustration, a first process could access data sets, a second process could identify payment options, and a third process could provide information about evaluated payment options. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described herein including methods 200 or 300. While executable instructions associated with the above methods are described as being stored on a computer-readable storage medium, it is to be appreciated that executable instructions associated with other example methods described herein may also be stored on a computer-readable storage medium. In different embodiments the example methods described herein may be triggered in different ways. In one embodiment, a method may be triggered manually by a user. In another example, a method may be triggered automatically.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), other optical medium, a random access memory (RAM), a read only memory (ROM), a memory chip or card, a memory stick, and other media from which a computer, a processor or other electronic device can read.

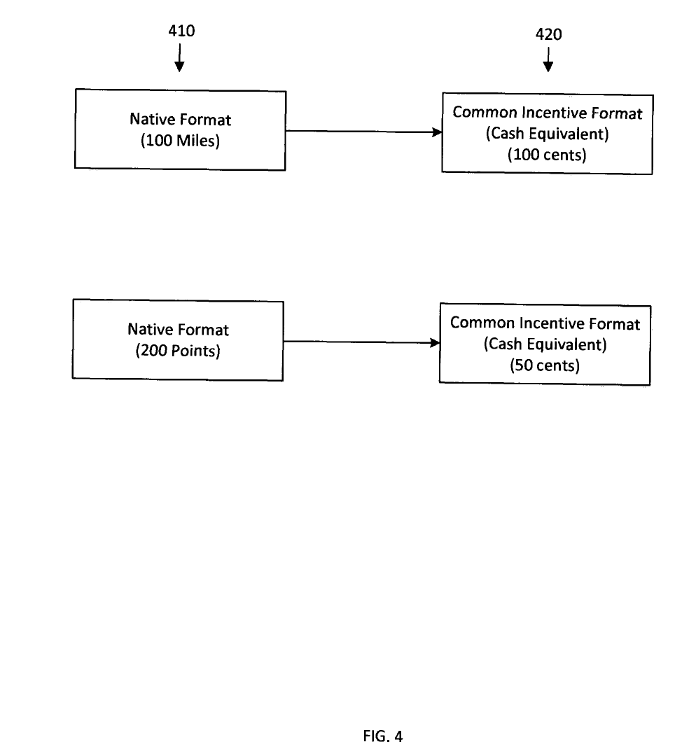

FIG. 4 illustrates an example transformation from an instrument specific incentive format 410 to a common incentive format 420. Transforming a reward from a format that is native to a payment instrument to a common format facilitates comparing the benefits that can be acquired by using different instruments. Instrument specific format 410 for a first instrument may be, for example, frequent flyer miles. This may also be referred to as a “native” format for an instrument. The instrument specific format for a second instrument may be, for example, points. Common incentive format 420 may be, for example, a monetary value (e.g., cash equivalent). Different instrument specific formats and different common incentive formats may be employed.

Consider purchasing an airline ticket. For ease of computation, imagine that the airline ticket costs $100. A credit card provided by the airline may offer 1 mile for every dollar spent on the airline credit card. Therefore, purchasing the airline ticket may produce 100 frequent flyer miles if the airline credit card is used. A credit card offered by an online retailer may offer 2 points for every dollar spent on the retailer credit card. Therefore, purchasing the airline ticket may produce 200 points if the online retailer credit card is used. FIG. 4 illustrates the reward generated in the two instrument specific formats. It may be difficult to compare miles to points. Therefore, example methods and apparatus may convert rewards to a common format to facilitate comparisons. In this simple example, a payment instrument rule may be consulted to learn that a frequent flyer mile has an approximate cash value of one cent. In different embodiments, the rule may include a subjective value provided by, for example, a user or analyst, or may include an objective value computed by a reward value analyzer or established by an agency (e.g., Internal Revenue Service). Similarly, a payment instrument rule may be consulted to learn that an online retailer point has an approximate cash value of one quarter of one cent. Thus, after conversion to the common format, the one hundred mile reward possible if the airline credit card is used is seen to be equivalent to approximately one hundred cents. Similarly, after conversion to the common format, the two hundred point reward possible if the online retailer credit card is used is seen to be equivalent to approximately fifty cents. In this case, the consumer may decide to complete the transaction using the airline credit card. While equivalent cash values are described, other common formats may be employed.

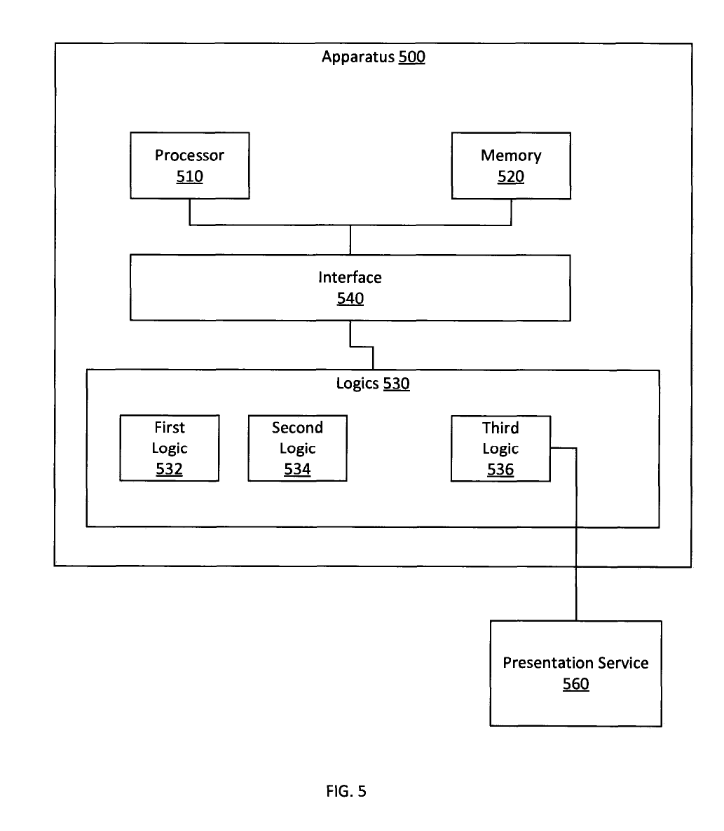

FIG. 5 illustrates an apparatus 500 that includes a processor 510, a memory 520, a set 530 of logics, and an interface 540 that connects the processor 510, the memory 520, and the set 530 of logics. Apparatus 500 may be, for example, a computer, a laptop computer, a tablet computer, a personal electronic device, a smart phone, a cash register, a point of sale device, or other device that can access and process data.

In one embodiment, the apparatus 500 may be a general purpose computer that has been transformed into a special purpose computer through the inclusion of the set 530 of logics. The set 530 of logics may be configured to evaluate incentive information associated with payment options available to a purchaser. In addition to evaluating the incentive information, apparatus 500 may provide information from which a consumer or consumer process can select a payment option for a particular purchase. In one embodiment, the methods described herein may be performed by apparatus 500. Apparatus 500 may interact with other apparatus, processes, and services through, for example, a computer network.

The set 530 of logics may include a first logic 532 that is configured to identify one or more payment options available for the purchase. First logic 532 may also be configured to acquire incentive information for the one or more payment options. In different embodiments, the first logic 532 may identify payment options from information provided by a physical entity (e.g., credit card) in a consumer's wallet. In another embodiment, the first logic 532 may identify payment options from information provided by a computer process (e.g., consumer payment instrument tracking process), may identify payment options from a database (e.g., electronic wallet), may identify information from a user input, or may identify options in other ways. In different embodiments, first logic 532 may acquire incentive information from an instrument, may acquire incentive information from a database, may acquire incentive information from an instrument provider, and may acquire information from other locations. In different embodiments the information may be acquired upon determining that a transaction is about to occur or at times not controlled by a transaction (e.g., periodically, based on connectivity, based on a change at the instrument provider).

In different embodiments, or at different times, depending on different conditions, the incentive information may be acquired in different ways. For example, incentive information may be acquired from a local data store if there is no connectivity or if a preference has been configured to acquire information locally. A shopper may decide to download incentive information before a shopping trip when they know they have desired connectivity rather than risking having no connectivity or having unacceptably slow connectivity at purchase time. However, if connectivity permits, incentive information may be acquired from a remote data store that aggregates incentive information, or even from individual incentive providers.

In one embodiment, acquiring incentive information may involve acquiring different pieces of information. For example, the first logic 532 may acquire a first value describing an incentive for the payment option where the first value is described in a format native to the payment option. The first logic 532 may also acquire a rule for converting data in the format native to the payment option to a common incentive format. The rule may also include information concerning how to handle threshold conditions. Threshold conditions may include, for example, moving from a first reward level (e.g., silver) to a second, higher reward level (e.g., gold), moving from a first payment situation (e.g., not overdrawn) to a second payment situation (e.g., overdrawn), or other conditions.

The first logic 532 may be configured to identify the payment options at different times. For example, the first logic 532 may identify the payment options at times including, but not limited to, upon determining that a purchase is about to be made, upon determining that a payment option has been added or deleted, periodically, and in response to a user signal. Similarly, the first logic 532 may acquire the incentive information at times including, but not limited to, upon determining that a purchase is about to be made, upon determining that a payment option has been added or deleted, upon determining that an incentive has changed, periodically, in response to a user signal, and in response to an incentive provider signal.

The set 530 of logics may also include a second logic 534 that is configured to provide a ranking of the payment options based on the acquired incentive information. In one embodiment, the second logic 534 may be configured to compute a reward that would be generated for each of the available instruments. In another embodiment, the second logic 534 may be configured to compute a reward that would be generated for a subset of the available instruments. In another embodiment, the second logic 534 may be configured to compute rewards until an acceptable reward level is found. Computing the rewards may include determining the purchase price, identifying the reward mechanism (e.g., points per purchase dollar, discount, points per purchase instance), and then computing the reward based on the price and the reward mechanism. In one embodiment the reward may be determined on apparatus 500. In another embodiment the reward may be determined off apparatus 500 and provided to apparatus 500. Once rewards have been computed, the payment options may be ranked based on the relative value of the rewards. For example, the instrument with the highest reward may be highest rated and the instrument with the lowest reward may be lowest rated.

In one embodiment, the second logic 534 may produce the ranking by computing values in the formats native to the payment options using the incentive information and data (e.g., price) about the item purchased. The second logic 534 may also produce values in the common incentive format based, at least in part, on the native format value. The ranking may then be produced using the common incentive values. In one embodiment, the native value may not be produced and stored separately but may instead be a temporary value considered when computing the common format value. In another embodiment, the common format value may not be produced and stored separately but may instead be a temporary value considered when comparing rewards.

Being able to rank the instruments may depend on being able to compare rewards using a common format. Instruments may, however, initially only store a reward in a native format. The native formats may include, for example, the number of miles per dollar, the points per dollar, the cash back per dollar, the discount per dollar, the length of a warranty, the possibility of an upgrade, the extent and duration of theft protection, the extent and duration of insurance, and other factors. To facilitate comparisons, the information available in the native format may be converted to a common format. One example common format is an equivalent dollar value. For example, one frequent flyer mile may be converted to one cent of equivalent cash value, one retailer point may be converted to three cents of equivalent cash value, and a warranty may be converted to the retail price for acquiring the warranty or the projected replacement cost of the item.

The set 530 of logics may also include a third logic 536 that is configured to produce an ordered presentation of the available payment options. In one embodiment, the order of the instruments in the presentation may be based, at least in part, on the ranking.

In one embodiment, producing the ordered presentation includes producing an entry for a payment option in the ordered presentation. An entry for a payment option may include an identifier of the payment option, an incentive value as described in a format native to the payment option, and an incentive value as described in the common incentive format. Different formats for an entry may be employed.

In one embodiment, apparatus 500 may identify the payment options, acquire the incentive information, produce the ranking, and produce the ordered presentation in less than one second. In another embodiment, apparatus 500 may identify the payment options, acquire the incentive information, produce the ranking, and produce the ordered presentation in less than one tenth of one second. In one embodiment, apparatus 500 may identify the payment options, acquire the incentive information, produce the ranking, and produce the ordered presentation in less than one hundredth of second. In one embodiment, apparatus 500 may identify the payment options, acquire the incentive information, produce the ranking, and produce the ordered presentation in less than one thousandth of a second.

In different embodiments, some processing may be performed on the apparatus 500 and some processing may be performed by an external service or apparatus. Thus, in one embodiment, apparatus 500 may also include a communication circuit that is configured to communicate with an external source to facilitate receipt or transmission of items including, but not limited to, purchase data, purchaser data, and payment instrument data. In one embodiment, the third logic 536 may interact with a presentation service 560 to facilitate displaying data using different presentations for different devices.

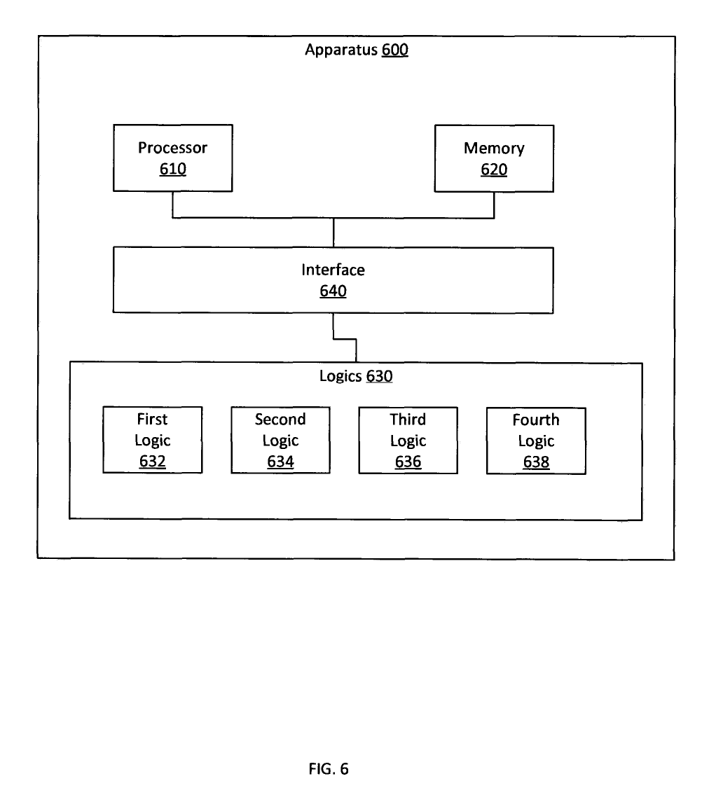

FIG. 6 illustrates an apparatus 600 that is similar to apparatus 500 (FIG. 5). For example, apparatus 600 includes a processor 610, a memory 620, a set of logics 630 (e.g., 632, 634, 636) that correspond to the set of logics 530 (FIG. 5) and an interface 640. However, apparatus 600 includes an additional fourth logic 638. The fourth logic 638 may be configured to populate and to repopulate entities including, but not limited to, memories, data stores, and data sets accessed by apparatus 600. The populating or repopulating may involve automatically acquiring information via computer communications (e.g., from an incentive provider), may involve acquiring information from a user, or may involve acquiring data from other entities in other ways. The populating or repopulating may occur at times including, but not limited to, when an apparatus or method is initialized, periodically, upon determining that a purchase is being considered, upon determining that a purchase is about to be made, upon determining that payment options have changed, upon determining that incentives have changed, upon determining that connectivity has been re-established, and upon detecting a control signal.

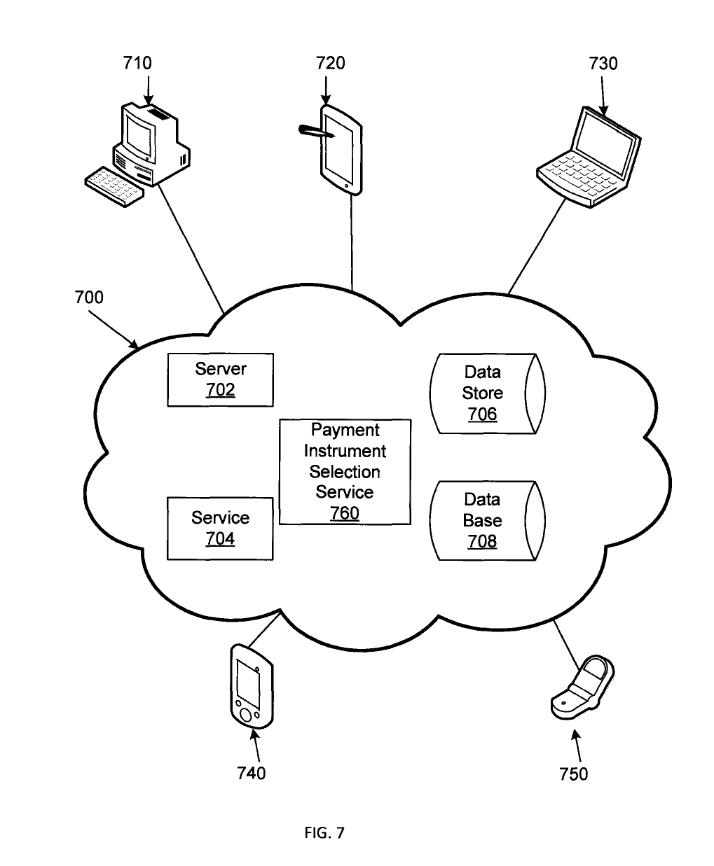

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices, over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example payment instrument selection service 760 residing in the cloud. The payment instrument selection service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud and may, therefore, be used by the payment instrument selection service 760.

FIG. 7 illustrates various devices accessing the payment instrument selection service 760 in the cloud. The devices include a computer 710, a tablet 720, a laptop computer 730, a personal digital assistant 740, and a mobile device (e.g., cellular phone, satellite phone) 750. The payment instrument selection service 760 may produce information that helps a shopper figure out which payment instrument (e.g., card with frequent flyer miles, card with discount, card with hotel points, card with cash back, card with insurance) to use for a particular purchase. The service 760 may identify payment options available for a purchase and identify incentives associated with the payment options. The service 760 may compare the benefits (e.g., miles, points, discount, cash back) that will be provided to the purchaser for different payment options and produce an ordered presentation of payment options to a consumer or to a purchase process. Service 760 may facilitate a consumer increasing the utility of participation in affinity programs, may facilitate a consumer achieving a reward status, may facilitate a consumer achieving a desired discount, or may generally improve the consumer's shopping experience.

It is possible that different users at different locations using different devices may access the payment instrument selection service 760 through different networks or interfaces. In one example, the payment instrument selection service 760 may be accessed by a mobile device 750. In another example, portions of payment instrument selection service 760 may reside on a mobile device 750.

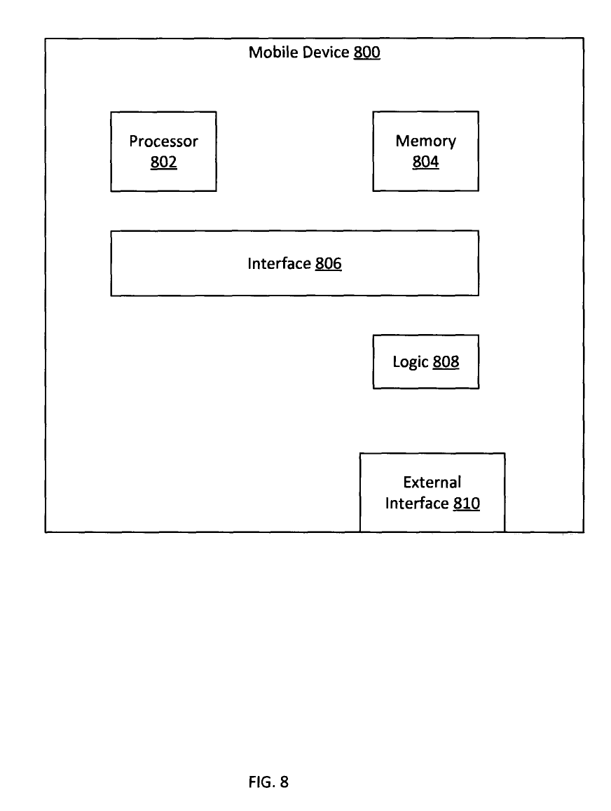

FIG. 8 illustrates an example mobile device 800. Mobile device 800 may be carried by a shopper when they go shopping. Mobile device 800 includes a processor 802, a memory 804, a logic 808, and an external interface 810 that may be connected by an interface 806. Mobile device 800 may be, for example, a cellular telephone, a network telephone, a satellite telephone, or other device. Generally describing an example configuration of the mobile device 800, the processor 802 may be a variety of various processors including dual microprocessor and other multi-processor architectures. The memory 804 may include volatile memory or non-volatile memory. Non-volatile memory may include, for example, read only memory (ROM), programmable ROM (PROM), and other memory. Volatile memory may include, for example, random access memory (RAM), dynamic RAM (DRAM), and other memory. The memory 804 can store an operating system that controls and allocates resources of the mobile device 800. The memory 804 may also store a payment instrument selection process that may be used to analyze the costs and benefits of various payment options to help a shopper decide how to pay for something.

The interface 806 may be a single internal bus interconnect architecture or other bus or mesh architectures. While a single bus is illustrated, it is to be appreciated that the mobile device 800 may communicate with various devices, logics, and peripherals using other busses (e.g., PCIE, 1394, USB, Ethernet). The interface 806 can be types including, for example, a memory bus, a memory controller, a peripheral bus, an external bus, a crossbar switch, or a local bus.

The mobile device 800 can operate in a network environment and thus may be connected to a network through network devices via the external interfaces 810. The mobile device 800 may be logically connected to remote computers through the network and the network devices. Through the network, the mobile device 800 may also be connected to services (e.g., service 760, FIG. 7) provided in the cloud (e.g., cloud 700, FIG. 7). Networks with which the mobile device 800 may interact include, but are not limited to, a local area network (LAN), a wide area network (WAN), a telephony network, a telephony system, a cellular system, a satellite system, and other networks.

Mobile device 800 may include a special purpose logic 808 that is configured to provide a functionality for the mobile device 800. For example, logic 808 may provide a client for interacting with a service (e.g., service 760, FIG. 7), or for performing payment instrument selection.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one of, A, B, and C” is employed herein, (e.g., a data store configured to store one of, A, B, and C) it is intended to convey the set of possibilities A, B, and C, (e.g., the data store may store only A, only B, or only C). It is not intended to require one of A, one of B, and one of C. When the applicants intend to indicate “at least one of A, at least one of B, and at least one of C”, then the phrasing “at least one of A, at least one of B, and at least one of C” will be employed.

To the extent that the phrase “one or more of, A, B, and C” is employed herein, (e.g., a data store configured to store one or more of, A, B, and C) it is intended to convey the set of possibilities A, B, C, AB, AC, BC, ABC, AA . . . A, BB . . . B, CC . . . C, AA . . . ABB . . . B, AA . . . ACC . . . C, BB . . . BCC . . . C, or AA . . . ABB . . . BCC . . . C (e.g., the data store may store only A, only B, only C, A&B, A&C, B&C, A&B&C, or other combinations thereof including multiple instances of A, B, or C). It is not intended to require one of A, one of B, and one of C. When the applicants intend to indicate “at least one of A, at least one of B, and at least one of C”, then the phrasing “at least one of A, at least one of B, and at least one of C” will be employed.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
accessing a purchaser data set associated with a purchaser;
accessing a purchase data set associated with an item to be purchased by the purchaser;
accessing a payment instrument data set associated with the purchaser;
controlling a computer to select a payment instrument for purchasing the item based, at least in part, on a reward available to the purchaser in response to purchasing the item using the payment instrument, where the reward is determined based on information in the purchaser data set, the purchase data set, and the payment instrument data set, and
providing information about the selected payment instrument.

2. The method of claim 1,
where accessing the purchaser data set includes one or more of: receiving the purchaser data set, receiving a link to the purchaser data set, binding to the purchaser data set, interacting with a computer file that stores a portion of the purchaser data set, interacting with a computer memory that stores a portion of the purchaser data set, communicating with a local data store that stores a portion of the purchaser data set, communicating with a remote data store that stores a portion of the purchaser data set, or communicating with a cloud-based data store that stores a portion of the purchaser data set,
where accessing the purchase data set includes one or more of: receiving the purchase data set, receiving a link to the purchase data set, binding to the purchase data set, interacting with a computer file that stores a portion of the purchase data set, interacting with a computer memory that stores a portion of the purchase data set, communicating with a local data store that stores a portion of the purchase data set, communicating with a local data store that stores a portion of the purchase data set, or communicating with a cloud-based data store that stores a portion of the purchase data set, and
where accessing the payment instrument data set includes one or more of: receiving the payment instrument data set, receiving a link to the payment instrument data set, binding to the payment instrument data set, interacting with a computer file that stores a portion of the payment instrument data set, interacting with a computer memory that stores a portion of the payment instrument data set, communicating with a local data store that stores a portion of the payment instrument data set, or communicating with a cloud-based data store that stores a portion of the payment instrument data set.

3. The method of claim 1, where the purchaser data set includes information concerning one or more of: a purchaser name, a purchaser identifier, a purchaser device identifier, a purchaser geographic location, or a set of payment instruments currently available to the purchaser, and
where the purchase data set includes information concerning one or more of: the item to be purchased, whether the purchase is an online purchase, whether the purchase is an in-person purchase, a promotion associated with the item, a frequency associated with the purchase, a vendor of the item, a geographic location of the vendor of the item, or a volatility of the item.

4. The method of claim 1, where the payment instrument data set includes information concerning a set of payment instruments currently available to the purchaser, and
where information concerning a member of the set of payment instruments includes one or more of: a payment instrument name, a payment instrument identifier, a payment instrument account identifier, a payment instrument reward, a payment instrument cost, a payment instrument boundary, a payment instrument history, a payment instrument comparative reward, a payment reward native format, a payment reward common format, a payment instrument conversion rule, a payment instrument balance, or a payment instrument application rule.

5. The method of claim 1, where controlling the computer to select the payment instrument comprises controlling the computer to provide information concerning a set of payment instrument options to the purchaser.

6. The method of claim 5, comprising controlling the computer to provide information concerning the set of payment instrument options in less than one second.

7. The method of claim 1, where selecting a payment instrument is based, at least in part, on a future scheduled payment associated with a payment instrument.

8. The method of claim 1, comprising:
populating the payment instrument data set with information automatically acquired via a computer communication from a payment instrument provider.

9. The method of claim 8, comprising:
repopulating at least a part of the payment instrument data set, where the repopulating occurs at at least one of: upon detecting a change in a reward associated with a payment instrument, upon the expiration of a time period, at a scheduled time, upon receiving a signal from a user, upon determining that a purchaser is considering making a purchase, upon detecting a change in a balance associated with an instrument, or upon detecting that a purchaser is about to make a purchase.

10. The method of claim 9, where repopulating at least a part of the payment instrument data set includes one or more of: receiving data from a payment instrument provider via a computer communication, or receiving data from a user.

11. The method of claim 1, comprising:
identifying rewards available for two or more payment instruments, and
controlling the computer to select the payment instrument from the two or more payment instruments that will produce the largest reward.

12. The method of claim 1, comprising identifying net rewards available for two or more payment instruments and controlling the computer to select the payment instrument from the two or more payment instruments that will produce the largest net reward.

13. The method of claim 1, comprising:
controlling a cloud service to select the payment instrument; and
controlling a device available to the purchaser to display information concerning the selected payment instrument to the purchaser, the device available to the purchaser being one of: a computer, a laptop computer, a tablet computer, a phone, a point of sale device, or a cash register.

14. A computer-readable medium storing computer-executable instructions that when executed by a computer control the computer to perform a method, the method comprising:
accessing data associated with a purchaser;
accessing data associated with an item being considered for purchase by the purchaser;
accessing data associated with two or more payment instruments available to the purchaser;
identifying net rewards available for two or more payment instruments available to the purchaser, where a net reward is computed from the data associated with the purchaser, the data associated with the purchase, and the data associated with the payment instrument, and
controlling a computer to provide to the purchaser, in less than one second, based, at least in part, on net rewards available to the purchaser, one or more payment instrument options selected from the two or more payment instruments, where a payment instrument option identifies a payment instrument and a net reward associated with the payment instrument,
where accessing the data associated with the purchaser, accessing the data associated with the item, and accessing the data associated with the payment instrument includes one or more of: receiving data, receiving a link to data, binding to data, interacting with a computer file that stores data, interacting with a computer memory that stores data, communicating with a local data store, or communicating with a cloud-based data store,
where the data associated with the purchaser includes information concerning a purchaser identifier, and a purchaser device identifier,
where the data associated with purchase includes information concerning the item to be purchased, a price of the item to be purchased, and a vendor of the item to be purchased, and
where the data associated with the two or more payment instruments includes information concerning payment instruments available to the purchaser at the time of purchase, and where the information concerning an available payment instrument includes a payment instrument identifier, a payment instrument account identifier, a payment instrument reward, a payment instrument rule, and a payment instrument cost.

15. An apparatus, comprising:
a processor;
a memory;
a set of logics configured to evaluate incentive information associated with payment options available to a purchaser for a purchase; and
an interface to connect the processor, the memory, and the set of logics;
the set of logics comprising:
a first logic configured to identify one or more payment options available for the purchase and to acquire incentive information for the one or more payment options available;
a second logic configured to produce a ranking of the one or more payment options available based on the acquired incentive information; and
a third logic configured to produce an ordered presentation of the one or more payment options available, where the order of the payment options in the ordered presentation is based, at least in part, on the ranking.

16. The apparatus of claim 15,
the first logic being configured to identify the one or more payment options available by accessing a repository of payment options associated with the purchaser, and
where the first logic acquires incentive information for a payment option by:
acquiring a first value describing an incentive for the payment option, where the first value is described in a format native to the payment option, and
acquiring a rule for converting data in the format native to the payment option to a common incentive format.

17. The apparatus of claim 16, the second logic being configured to produce the ranking by:
computing a third value in the format native to the payment option based, at least in part, on the first value, on the item purchased, and the price of the item purchased,
computing a fourth value in the common incentive format based, at least in part, on the third value and the rule, and
producing the ranking based on the fourth value.

18. The apparatus of claim 17, where producing the ordered presentation includes producing an entry for a payment option in the ordered presentation, where a payment option includes an identifier of the payment option, an incentive value as described in a format native to the payment option, and an incentive value as described in the common incentive format.

19. The apparatus of claim 18,
where the first logic identifies the one or more payment options available upon determining that a purchase is being considered,
where the first logic acquires the incentive information upon determining that a purchase is being considered, and
where the apparatus identifies the one or more payment options available, acquires the incentive information, produces the ranking, and produces the ordered presentation in less than one second.

20. The apparatus of claim 18, comprising a fourth logic configured to refresh one or more of: the repository of payment options, or the incentive information for the payment options available, where the refresh occurs at times including, at least one of: upon detecting a change in an available reward, upon the expiration of a time period, at a scheduled time, upon receiving a signal from a user, upon detecting that a purchase is being considered, or upon detecting that a purchase is about to be made,
where refreshing the repository of payment options and the incentive information includes one or more of: receiving data from a payment instrument provider via a computer communication, or receiving data from a user.
